(19) United States
(12) Patent Application Publication
(10) Pub. No.: US 2022/0297666 A1
(43) Pub. Date: Sep. 22, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Hirokazu Oguma, Wako-shi (JP); Hisaya Oiwa, Tokyo (JP); Kenta Suzuki, Tokyo (JP)

(21) Appl. No.: 17/672,735

(22) Filed: Feb. 16, 2022

(30) Foreign Application Priority Data
Mar. 17, 2021 (JP) 2021-043913

(51) Int. Cl. B60W 20/13; B60W 10/26; B60W 10/08; B60L 50/60

(52) U.S. Cl. CPC B60W 20/13; B60W 10/26; B60W 10/08; B60L 50/60; B60W 2710/242; B60W 2510/085; B60W 2710/086; B60W 2720/28

(57) ABSTRACT

A vehicle control device includes a processor configured to execute computer-readable instructions to perform. The processor is configured to acquiring a state of a first battery and a state of a second battery, acquiring motor power that is consumed by a motor that outputs motive power for traveling, detecting a rotation state of a drive wheel driven by the motor, calculating a first upper power limit value on the basis of the state of the first battery, calculating a second upper power limit value on the basis of the state of the second battery, and controlling the amount of electric power that is supplied from each of the first battery and the second battery to the motor on the basis of the calculated first and second upper power limit values. The controlling the amount of electric power includes determining whether to compensate for the motor power equivalent to the amount of change or limit compensation for the motor power equivalent to the amount of change when the change in the rotation state satisfies a reference condition.

### CROSS-REFERENCE TO RELATED APPLICATION

Priority is claimed on Japanese Patent Application No. 2021-043913, filed Mar. 17, 2021, the content of which is incorporated herein by reference.

### BACKGROUND OF THE INVENTION

### Field of the Invention

The present invention relates to a vehicle control device, a vehicle control method, and a storage medium.

### Description of Related Art

In recent years, for example, development of electric vehicles such as a hybrid electric vehicle (HEV) and a plug-in hybrid electric vehicle (PHEV), each of which performs traveling using an electric motor driven with at least electric power supplied by a battery (a secondary battery), has progressed. In these electric vehicles, the driving of the electric motor is controlled on the basis of the amount of electric power stored in the battery.

Incidentally, slip may occur in all vehicles including electric vehicles due to, for example, an influence of a road surface state or the like. When slip occurs in an electric vehicle, the number of rotations of the electric motor increases and hence a large current flows through the electric motor. A voltage of the battery mounted in the electric vehicle decreases significantly and the decrease in the voltage causes the battery to deteriorate.

Technology related to this is disclosed in, for example, Japanese Unexamined Patent Application, First Publication No. 2016-040968 and Japanese Unexamined Patent Application, First Publication No. 2018-098947. In Japanese Unexamined Patent Application, First Publication No. 2016-040968, a case where the output torque of the electric motor decreases with a rate of slip that has occurred is disclosed. In Japanese Unexamined Patent Application, First Publication No. 2018-098947, a case where a decreasing rate of the output torque of the electric motor is changed according to whether or not the voltage of the battery has decreased to a prescribed value or less when the output torque of the electric motor is decreased due to the occurrence of slip is disclosed. In Japanese Unexamined Patent Application, First Publication No. 2018-098947, when the voltage of the battery is less than or equal to the prescribed value, a decrease in the output torque of the electric motor is limited as compared with when the voltage is not less than or equal to the prescribed value.

Further, in a recent electric vehicle system, a combination of two different types of batteries such as a low-power and high-capacity battery (hereinafter referred to as a “high-capacity type battery”) and a low-capacity and high-power battery (hereinafter referred to as a “high-power type battery”) has also been put into practical use. Slip may also occur in such an electric vehicle.

In relation to this, in, for example, Japanese Unexamined Patent Application, First Publication No. 2010-098823, a case where electric power equivalent to the amount exceeding an input/output limit is distributed to the other battery when one battery is charged and discharged with electric power exceeding the input/output limit due to the occurrence of slip in an electric vehicle equipped with the two batteries is disclosed.

However, as in Japanese Unexamined Patent Application, First Publication No. 2016-040968 and Japanese Unexamined Patent Application, First Publication No. 2018-098947, when the output torque of the electric motor is decreased when slip has occurred, the behavior of the electric vehicle may become unstable due to a change in the output torque. In Japanese Unexamined Patent Application, First Publication No. 2010-098823, the distribution of charging/discharging power of the two batteries when slip has occurred is disclosed, but study of the behavior of the electric vehicle is not sufficient and it is not always possible to cause an electric vehicle to travel in a stable manner when slip has occurred.

### SUMMARY OF THE INVENTION

The present invention has been made on the basis of the recognition of the above-described problems and an objective of the present invention is to provide a vehicle control device, a vehicle control method, and a storage medium capable of reducing the number of factors that cause a battery to deteriorate and stabilizing the behavior of an electric vehicle when charging/discharging power of the battery is controlled due to slip that has occurred in the electric vehicle.

A vehicle control device, a vehicle control method, and a storage medium according to the present invention adopt the following configurations.

(1): According to an aspect of the present invention, there is provided a vehicle control device including a processor configured to execute computer-readable instructions to perform: acquiring a state of a first battery and a state of a second battery; acquiring information of motor power that is consumed by a motor that outputs motive power for traveling; detecting a rotation state of a drive wheel driven by the motor; calculating a first upper power limit value that is an upper power limit value of the first battery on the basis of the state of the first battery; calculating a second upper power limit value that is an upper power limit value of the second battery on the basis of the state of the second battery; and controlling the amount of electric power that is supplied from each of the first battery and the second battery to the motor on the basis of the calculated first and second upper power limit values, wherein the controlling the amount of electric power includes determining whether to compensate for the motor power equivalent to the amount of change due to a change in the rotation state with electric power of the first battery and the second battery or limit compensation for the motor power equivalent to the amount of change on the basis of the first upper power limit value, the second upper power limit value, and the motor power when the change in the rotation state satisfies a reference condition.

(2): In the above-described aspect (1), the reference condition is related to an increasing rate of the number of rotations of the drive wheel representing the rotation state, and the processor is configured to execute the computer-readable instructions to perform: determining that the change in the rotation state satisfies the reference condition when the increasing rate exceeds a reference value.

(3): In the above-described aspect (2), the processor is configured to execute the computer-readable instructions to perform: determining to compensate for the motor power equivalent to the amount of change when the motor power is less than or equal to a maximum power value obtained by combining the first upper power limit value and the second upper power limit value, and determining to limits the compensation for the motor power equivalent to the amount of change when the motor power exceeds the maximum power value.

(4): In the above-described aspect (2), the processor is configured to execute the computer-readable instructions to perform: acquiring out-of-traveling consumption power as electric power to be consumed outside of the motor; determining to compensate for the motor power equivalent to the amount of change when the motor power is less than or equal to a value obtained by subtracting the out-of-traveling consumption power from a maximum power value obtained by combining the first upper power limit value and the second upper power limit value; and determining to limit the compensation for the motor power equivalent to the amount of change when the motor power exceeds the value obtained by subtracting the out-of-traveling consumption power from the maximum power value.

(5): In the above-described aspect (3) or (4), when it is determined to compensate for the motor power equivalent to the amount of change and when the motor power is less than or equal to the maximum power value and the motor power is less than or equal to the first upper power limit value, the processor is configured to execute the computer-readable instructions to perform: causing the motor power equivalent to the amount of change to be compensated for with surplus power less than or equal to the first upper power limit value in the first battery and maintains the amount of electric power to be supplied from the second battery.

(6): In the above-described aspect (3) or (4), when it is determined to compensate for the motor power equivalent to the amount of change, the processor is configured to execute the computer-readable instructions to perform: causing the motor power equivalent to the amount of change to be compensated for with surplus power less than or equal to the second upper power limit value in the second battery.

(7): In any one of the above-described aspects (1) to (6), the first battery is a high-capacity and low-power battery, and the second battery is a battery having lower capacity and higher power than the first battery.

(8): According to an aspect of the present invention, there is provided a vehicle control method including: acquiring, by a computer, a state of a first battery and a state of a second battery; acquiring, by the computer, information of motor power that is consumed by a motor that outputs motive power for traveling; detecting, by the computer, a rotation state of a drive wheel driven by the motor; calculating, by the computer, a first upper power limit value that is an upper power limit value of the first battery on the basis of the state of the first battery; calculating, by the computer, a second upper power limit value that is an upper power limit value of the second battery on the basis of the state of the second battery; controlling, by the computer, the amount of electric power that is supplied from each of the first battery and the second battery to the motor on the basis of the calculated first and second upper power limit values; and determining, by the computer, whether to compensate for the motor power equivalent to the amount of change due to a change in the rotation state with electric power of the first battery and the second battery or limit compensation for the motor power equivalent to the amount of change on the basis of the first upper power limit value, the second upper power limit value, and the motor power when the change in the rotation state satisfies a reference condition.

(9): According to an aspect of the present invention, there is provided a non-transitory computer-readable storage medium storing a program for causing a computer to: acquire a state of a first battery and a state of a second battery; acquire information of motor power that is consumed by a motor that outputs motive power for traveling; detect a rotation state of a drive wheel driven by the motor; calculate a first upper power limit value that is an upper power limit value of the first battery on the basis of the state of the first battery; calculate a second upper power limit value that is an upper power limit value of the second battery on the basis of the state of the second battery; control the amount of electric power that is supplied from each of the first battery and the second battery to the motor on the basis of the calculated first and second upper power limit values; and determine whether to compensate for the motor power equivalent to the amount of change due to a change in the rotation state with electric power of the first battery and the second battery or limit compensation for the motor power equivalent to the amount of change on the basis of the first upper power limit value, the second upper power limit value, and the motor power when the change in the rotation state satisfies a reference condition.

According to the above-described aspects (1) to (9), it is possible to reduce the number of factors that cause a battery to deteriorate and stabilize the behavior of an electric vehicle when charging/discharging power of the battery is controlled due to slip that has occurred in the electric vehicle.

### BRIEF DESCRIPTION OF THE DRAWINGS

FIG. 1 is a diagram showing an example of a configuration of a vehicle according to an embodiment.

FIG. 2 is a diagram showing an example of a change in torque of a traveling motor in the vehicle according to an embodiment.

FIG. 3 is a diagram showing an example of a configuration of a control device provided in the vehicle according to the embodiment.

FIG. 4 is a diagram showing an example of a state in which electric power is output to the traveling motor according to control of the control device provided in the vehicle according to the embodiment.

FIG. 5 is a diagram schematically showing an example of a state in which the control device provided in the vehicle according to the embodiment controls electric power to be output to the traveling motor.

FIG. 6 is a flowchart showing an example of a flow of a process executed when electric power to be output to the traveling motor is controlled in the control device provided in the vehicle according to the embodiment.

### DETAILED DESCRIPTION OF THE INVENTION

Hereinafter, embodiments of a vehicle control device, a vehicle control method, and a storage medium of the present invention will be described with reference to the drawings. As used throughout this disclosure, the singular forms “a,” “an,” and “the” include plural reference unless the context clearly dictates otherwise.

### [Configuration of Vehicle]

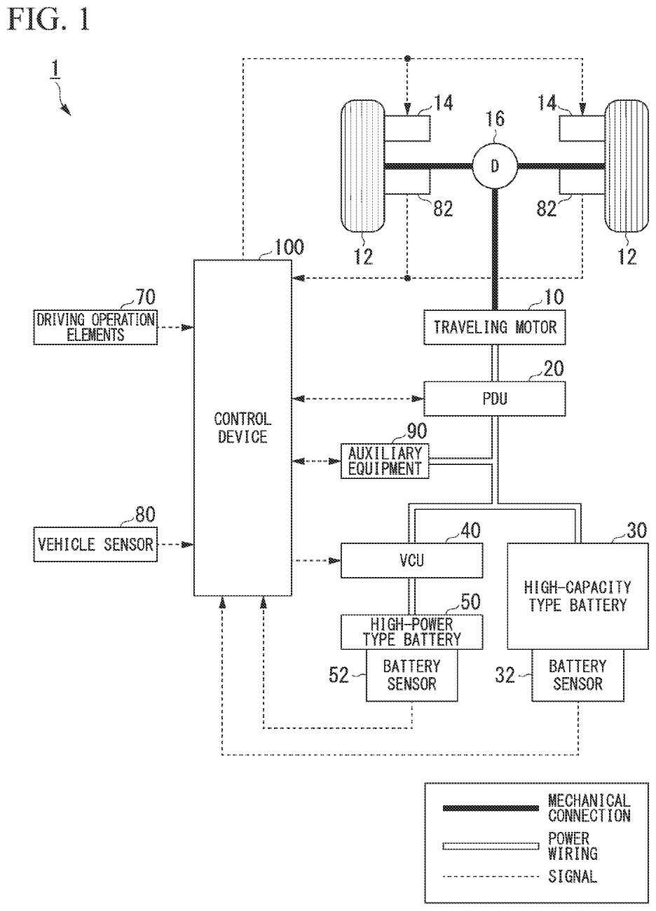

FIG. 1 is a diagram showing an example of a configuration of a vehicle according to an embodiment. A vehicle 1 is an electric vehicle (EV) (hereinafter simply referred to as a “vehicle”) that travels using an electric motor driven by electric power supplied from a traveling battery (a secondary battery). The vehicle 1 is an electric vehicle of a multi-battery system equipped with two types of batteries including a high-capacity type battery having low power and high capacity and a high-power type battery having low capacity and high power. The vehicle 1 travels by driving the electric motor with the electric power supplied from one of the batteries or a combination of the electric power supplied from both batteries. Vehicles to which the present invention is applied include, for example, general vehicles of four-wheeled vehicles, saddle-riding type two-wheeled vehicles, three-wheeled vehicles (including two front wheel and one rear wheel vehicles in addition to one front wheel and two rear wheel vehicles), and a vehicle that travels using an electric motor driven by electric power supplied from a traveling battery such as an assisted bicycle. The vehicle 1 may be, for example, a hybrid electric vehicle (HEV) that travels by further combining electric power supplied according to running of an internal combustion engine that uses fuel as an energy source, such as a diesel engine or a gasoline engine.

The vehicle 1 includes, for example, a traveling motor 10, a drive wheel 12, a brake device 14, a speed reducer 16, a power drive unit (PDU) 20, a high-capacity type battery 30, a battery sensor 32, a voltage control unit (VCU) 40, a high-power type battery 50, a battery sensor 52, a driving operation elements 70, a vehicle sensor 80, a wheel speed sensor 82, an auxiliary equipment 90, and a control device 100.

The traveling motor 10 is a rotating electric device for traveling of the vehicle 1. The traveling motor 10 is, for example, a three-phase alternating current (AC) electric motor. A rotor of the traveling motor 10 is connected to the speed reducer 16. The traveling motor 10 is driven (rotated) with electric power supplied from the high-capacity type battery 30 or electric power obtained by adding electric power supplied from the high-power type battery 50 via the VCU 40 to electric power supplied from the high-capacity type battery 30. The traveling motor 10 transfers its own rotational power to the speed reducer 16. The traveling motor 10 may operate as a regenerative brake using the kinetic energy of the vehicle 1 during deceleration to generate electricity. The traveling motor 10 is an example of a “motor” in the claims.

The brake device 14 arranged on the drive wheel 12 includes, for example, a brake caliper, a cylinder that transfers hydraulic pressure to the brake caliper, and an electric motor that causes a cylinder to generate the hydraulic pressure. The brake device 14 may include a mechanism for transferring the hydraulic pressure generated by an operation of a user (a driver) of the vehicle 1 on a brake pedal (not shown) to the cylinder via a master cylinder as a backup. The brake device 14 is not limited to the above-described configuration and may be an electronically controlled hydraulic brake device that transfers the hydraulic pressure of the master cylinder to the cylinder.

The speed reducer 16 is, for example, a differential gear. The speed reducer 16 causes a driving force of a shaft to which the traveling motor 10 is connected, i.e., rotational power of the traveling motor 10, to be transferred to an axle to which the drive wheel 12 is connected. The speed reducer 16 may include, for example, a so-called transmission mechanism in which a plurality of gears or shafts are combined to change the rotational speed of the traveling motor 10 in accordance with a gear ratio and cause the rotational speed to be transferred to the axle. The speed reducer 16 may also include, for example, a clutch mechanism that directly connects or separates the rotational power of the traveling motor 10 to or from the axle.

The PDU 20 is, for example, an AC-direct current (DC) converter. The PDU 20 converts DC power supplied from the high-capacity type battery 30 or supplied from the high-power type battery 50 via the VCU 40 in addition to the supply from the high-capacity type battery 30 into AC power for driving the traveling motor 10 and outputs the AC power to the traveling motor 10. The PDU 20 converts the AC power generated by the traveling motor 10 operating as a regenerative brake into DC power and outputs the DC power to the high-capacity type battery 30 or the VCU 40 (i.e., the high-power type battery 50). The PDU 20 may perform an output operation after a step-up or -down operation according to a power output destination.

The VCU 40 is, for example, a DC-DC converter. The VCU 40 steps up a voltage of the electric power supplied (discharged) from the high-power type battery 50 to a voltage similar to a voltage when the high-capacity type battery 30 supplies electric power to the PDU 20 and outputs the electric power whose voltage has been stepped up to the PDU 20. The VCU 40 steps down a voltage of the electric power generated by the traveling motor 10 operated as a regenerative brake output by the PDU 20, outputs the electric power whose voltage has been stepped down to the high-power type battery 50, and causes the high-power type battery 50 to store (to be charged with) the electric power whose voltage has been stepped down.

The high-capacity type battery 30 and the high-power type battery 50 are batteries each including a secondary battery capable of repeating charging and discharging processes as a power storage unit such as a lithium-ion battery. Each of the high-capacity type battery 30 and the high-power type battery 50 may have a removable configuration that can be easily attached to and detached from the vehicle 1 such as a cassette-type battery pack or a stationary configuration that is not easily attached to and detached from the vehicle 1. For example, the high-capacity type battery 30 has a stationary configuration and the high-power type battery 50 has a removable configuration. The secondary battery provided in each of the high-capacity type battery 30 and the high-power type battery 50 is, for example, a lithium-ion battery. As the secondary battery provided in each of the high-capacity type battery 30 and the high-power type battery 50, for example, in addition to a lead storage battery, a nickel-hydrogen battery, a sodium-ion battery, and the like, a capacitor such as an electric double-layer capacitor or a composite battery in which a secondary battery and a capacitor are combined are conceivable, but the configuration of the secondary battery may be of any type. Each of the high-capacity type battery 30 and the high-power type battery 50 stores (is charged with) the electric power introduced from an external charger (not shown) of the vehicle 1 and is discharged to output the stored electric power for causing the vehicle 1 to travel. Each of the high-capacity type battery 30 and the high-power type battery 50 stores (is charged with) the electric power supplied via the PDU 20 or the VCU 40 and generated by the traveling motor 10 operated as a regenerative brake and is discharged so that the stored electric power is used for traveling (for example, acceleration) of the vehicle 1. The high-capacity type battery 30 is an example of a “first battery” in the claims and the high-power type battery 50 is an example of a “second battery” in the claims.

The battery sensor 32 is connected to the high-capacity type battery 30. The battery sensor 32 detects physical quantities such as a voltage, a current, and a temperature of the high-capacity type battery 30. The battery sensor 32 includes, for example, a voltage sensor, a current sensor, and a temperature sensor. The battery sensor 32 detects the voltage of the high-capacity type battery 30 using the voltage sensor, detects the current of the high-capacity type battery 30 using the current sensor, and detects the temperature of the high-capacity type battery 30 using the temperature sensor. The battery sensor 32 outputs information (hereinafter referred to as “high-capacity type battery information”) such as the voltage value, the current value, and the temperature of the high-capacity type battery 30 that have been detected to the control device 100.

The battery sensor 52 is connected to the high-power type battery 50. The battery sensor 52 detects physical quantities such as a voltage, a current, and a temperature of the high-power type battery 50. The configuration of the battery sensor 52 is similar to that of the battery sensor 32. The battery sensor 52 outputs information (hereinafter referred to as “high-power type battery information”) such as the voltage value, the current value, and the temperature of the high-power type battery 50 that have been detected to the control device 100.

The driving operation elements 70 include, for example, an accelerator pedal, a brake pedal, a shift lever, a steering wheel, a variant steering wheel, a joystick, and other operation elements. The driving operation element 70 is equipped with a sensor that detects whether or not the user (the driver) of the vehicle 1 has performed an operation on each operation element or the amount of operation. The driving operation element 70 outputs a detection result of the sensor to the control device 100. For example, an accelerator opening degree sensor is attached to the accelerator pedal, detects the amount of operation on the accelerator pedal by the driver and outputs the detected amount of operation as an accelerator opening degree to the control device 100. For example, a brake depression amount sensor is attached to the brake pedal, detects the amount of operation on the brake pedal by the driver, and outputs the detected amount of operation as the amount of brake depression to the control device 100.

The vehicle sensor 80 detects the traveling state of the vehicle 1. For example, the vehicle sensor 80 includes a wheel speed sensor 82 that detects a wheel speed of each drive wheel 12 such as a rotational speed (the number of rotations) of each drive wheel 12 of the vehicle 1. For example, the wheel speed sensor 82 is attached to a portion of the axle to which each drive wheel 12 is connected and detects the wheel speed of each drive wheel 12 by detecting the number of rotations of the axle. The wheel speed sensor 82 outputs information (hereinafter referred to as “wheel speed information”) indicating the detected wheel speed of each drive wheel 12 to the control device 100. The vehicle sensor 80 may include, for example, a vehicle speed sensor that detects the speed of the vehicle 1 or an acceleration sensor that detects the acceleration of the vehicle 1. The vehicle speed sensor may include, for example, a speed calculator, and the speed (the vehicle speed) of the vehicle 1 may be derived (detected) by integrating wheel speeds detected by wheel speed sensors 82 attached to drive wheels 12 of the vehicle 1. The vehicle sensor 80 may include, for example, a yaw rate sensor that detects an angular velocity around a vertical axis of the vehicle 1, a direction sensor that detects a direction of the vehicle 1, and the like. The vehicle sensor 80 outputs information (hereinafter referred to as “traveling state information”) indicating the detected traveling state of the vehicle 1 to the control device 100. The traveling state information may include wheel speed information. The wheel speed sensor 82 or the vehicle sensor 80 is an example of a “rotation state detector” in the claims and the wheel speed is an example of a “rotation state” in the claims.

The auxiliary equipment 90 is in-vehicle equipment provided in the vehicle 1, such as an air conditioning device (a so-called air conditioner) or an accessory socket for power supply (a so-called cigar socket). The auxiliary equipment 90 may be, for example, a universal serial bus (USB) terminal, a commercial power outlet for operating a household electric appliance or a personal computer, or the like. The auxiliary equipment 90 is not equipment directly related to the traveling of the vehicle 1, but operates by consuming the electric power supplied from the high-power type battery 50 via the high-capacity type battery 30 or the VCU 40, i.e., is equipment that consumes electric power outside of the traveling motor 10.

The control device 100 controls running or operations of the PDU 20 and the VCU 40 in accordance with a detection result output by each sensor provided in the driving operation element 70, i.e., an operation on each operation element by the user (the driver) of the vehicle 1. For example, the control device 100 controls the running or operations of the PDU 20 and the VCU 40 in accordance with the accelerator opening degree detected by the accelerator opening degree sensor. At this time, the control device 100 controls the running or operations of the PDU 20 and the VCU 40, for example, in consideration of the gear ratio of the transmission mechanism controlled by the control device 100, the vehicle speed included in the traveling state information output by the vehicle sensor 80, and the like. Thereby, the control device 100 controls the amount of electric power that is supplied to the traveling motor 10, i.e., a driving force of the traveling motor 10.

The control device 100 may include, for example, separate control devices such as a motor controller, a PDU controller, a battery controller, and a VCU controller. For example, the control device 100 may be replaced with a control device such as a motor electronic control unit (ECU), a PDU-ECU, a battery ECU, or a VCU-ECU.

Each of the control device 100, the motor controller constituting the control device 100, the PDU controller, the battery controller, and the VCU controller may be implemented, for example, by a hardware processor such as a central processing unit (CPU) executing the program (software). Some or all of the functions of these components may be implemented by hardware (including a circuit unit; circuitry) such as a large-scale integration (LSI) circuit, an application-specific integrated circuit (ASIC), a field-programmable gate array (FPGA), or a graphics processing unit (GPU) or may be implemented by software and hardware in cooperation. Some or all of the functions of these components may be implemented by a dedicated LSI circuit. The program may be pre-stored in a storage device (a storage device including a non-transitory storage medium) such as a hard disk drive (HDD) or a flash memory provided in the vehicle 1 or may be stored in a removable storage medium (a non-transitory storage medium) such as a DVD or a CD-ROM and installed in the HDD or the flash memory provided in the vehicle 1 when the storage medium is mounted in a drive device provided in the vehicle 1.

When the vehicle 1 travels, the control device 100 controls a discharging process on electric power from the high-capacity type battery 30, a charging process on electric power to the high-capacity type battery 30, a discharging process on electric power from the high-power type battery 50, and a charging process on electric power to the high-power type battery 50. The control device 100 may control a discharging process on electric power from each battery and a charging process on electric power to each battery on the basis of a traveling mode of the vehicle 1. In this case, the traveling mode of the vehicle 1 may be automatically switched by the control device 100 on the basis of the accelerator opening degree and the amount of brake depression output by the driving operation elements 70 and the traveling state information output by the vehicle sensor 80 or may be manually and intentionally switched by the driver using a traveling mode changeover switch (not shown) provided in the driving operation element 70.

In the normal traveling of the vehicle 1, the control device 100 causes the electric power to be output from the high-capacity type battery 30 to the PDU 20. Thereby, the vehicle 1 travels with the rotational power of the traveling motor 10 driven by electric power supplied (discharged) from the high-capacity type battery 30. Further, for example, when a large driving force of the traveling motor 10 is required for the vehicle 1 to travel such as when the vehicle 1 climbs a steep slope or accelerates, the control device 100 causes the VCU 40 to output electric power from the high-power type battery 50 to the PDU 20 if the supply of electric power exceeding an upper limit value of electric power capable of being output by the high-capacity type battery 30 (hereinafter referred to as an “upper power limit value”) is necessary. That is, the control device 100 compensates for a shortage amount of electric power in the amount of electric power supplied from the high-capacity type battery 30 to the upper power limit value with the amount of electric power output from the high-power type battery 50. Thereby, the vehicle 1 travels with the rotational power of the traveling motor 10 driven by electric power obtained by combining the electric power supplied (discharged) from the high-capacity type battery 30 and the electric power supplied (discharged) from the high-power type battery 50. The upper power limit value can be calculated on the basis of the high-capacity type battery information output by the battery sensor 32. More specifically, for example, it is possible to obtain a state of charge (SOC) indicating a charging state of the high-capacity type battery 30 on the basis of a voltage value and a current value included in the high-capacity type battery information and calculate an upper power limit value at a present time point in the high-capacity type battery 30 on the basis of the obtained SOC and information of a temperature included in the high-capacity type battery information.

In this way, the control device 100 controls the running or operations of the PDU 20 and the VCU 40 in accordance with the operation of the driving operation element 70 by the driver and causes the traveling motor 10 to be driven by causing electric power to be output from the high-capacity type battery 30 and the high-power type battery 50. The control device 100 is an example of a “vehicle control device” in the claims.

### [Control of Power Supply for Traveling Motor]

Incidentally, when the vehicle 1 is traveling, it is assumed that the drive wheels 12 idle, i.e., slip occurs, due to an influence of a road surface state, for example, such as snow or rain on the road surface. When slip occurs, the rotational speed of the traveling motor 10 may increase and an unexpectedly large current may flow through the traveling motor 10. There is a problem that the voltage of the high-capacity type battery 30 (which may also include the high-power type battery 50) from which electric power is supplied in normal traveling may be greatly reduced and the deterioration of the high-capacity type battery 30 may be accelerated. Thus, when the wheel speed sensor 82 detects that the rotational speed of the drive wheel 12 has increased, the control device 100 controls the running or operations of the PDU 20 and the VCU 40 so that the voltage of the high-capacity type battery 30 or the high-power type battery 50 is not significantly reduced. In other words, the control device 100 controls the electric power that is output to the traveling motor 10 so that the high-capacity type battery 30 and the high-power type battery 50 are protected.

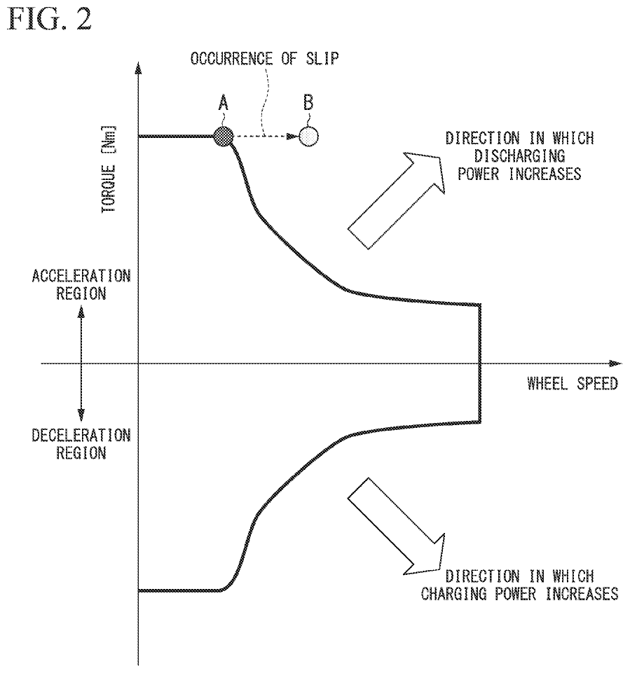

FIG. 2 is a diagram showing an example of a change in torque of the traveling motor 10 in the vehicle 1 according to the embodiment. Although the control device 100 controls the driving force (torque) of the traveling motor 10 on the basis of the accelerator opening degree, the gear ratio, the vehicle speed, and the like as described above, it is assumed that the accelerator opening, the gear ratio, or the like does not change during control.

FIG. 2 shows an example of a change in the torque [Nm] of the traveling motor 10 with respect to the wheel speed of the vehicle 1. The wheel speed is a value corresponding to the number of rotations [rpm] of the drive wheels 12 detected by the wheel speed sensor 82 attached to the drive wheel 12. The wheel speed is a value proportional to the vehicle speed of the vehicle 1 in a state in which no slip occurs. The control device 100 can cause the torque [Nm] of the traveling motor 10 to be changed by controlling the amount of supply of electric power to be output from the PDU 20 to the traveling motor 10. The relationship between a wheel speed and a torque shown in FIG. 2 is determined, for example, according to the capability of the high-capacity type battery 30 to supply electric power.

More torque is required in the traveling motor 10 so that the vehicle 1 accelerates from a state in which the vehicle speed of the vehicle 1 is low (the wheel speed is low). Thus, as shown in FIG. 2, the control device 100 causes more electric power (discharging power in FIG. 2) to be supplied from the PDU 20 to the traveling motor 10. Subsequently, as the vehicle speed of the vehicle 1 increases (the wheel speed increases), the torque required in the traveling motor 10 for acceleration decreases. Thus, as shown in FIG. 2, the control device 100 decreases the electric power to be supplied from the PDU 20 to the traveling motor 10 as the vehicle speed increases.

Here, when the vehicle 1 is accelerated, for example, a case where the wheel speed increases due to the slip generated when the relationship between the wheel speed and the torque is in state A and the relationship between the wheel speed and the torque is in state B is taken into consideration. That is, a case where the traveling motor 10 is in a state in which more electric power is required is taken into consideration.

When the relationship between the wheel speed and the torque is in state B, control is performed so that the relationship between the wheel speed and the torque is on a line indicated in FIG. 2 by limiting the torque of the traveling motor 10, i.e., by reducing the electric power that is supplied to the traveling motor 10, in the conventional technology. In the conventional technology, control is performed so that the torque limitation is released and the relationship between the wheel speed and the torque returns to state A when slip that has occurred converges due to the torque limitation and the wheel speed becomes a wheel speed immediately before the slip occurs. In the conventional technology, a case where a large current flows through the traveling motor 10 due to the slip that has occurred and the voltage of the high-capacity type battery 30 significantly decreases is limited according to such control.

However, if the torque of the traveling motor 10 is limited and lowered when slip has occurred, the behavior of the vehicle 1 may become unstable due to a change in the torque. Thus, the control device 100 does not limit the torque of the traveling motor 10 immediately when slip occurs as in the conventional technology and first controls a discharging process of the high-capacity type battery 30 or the high-power type battery 50 so that electric power required in association with an increase in the rotational speed of the drive wheel 12 (the number of rotations of the traveling motor 10) is compensated for. At this time, the control device 100 may perform control so that the high-power type battery 50 is discharged regardless of whether or not electric power to be compensated for exceeds the upper power limit value of the high-capacity type battery 30 or may perform control so that the high-power type battery 50 is discharged when electric power to be compensated for exceeds the upper power limit value of the high-capacity type battery 30. That is, the control device 100 may perform control so that the high-capacity type battery 30 is discharged when the electric power to be compensated for does not exceed the upper power limit value of the high-capacity type battery 30. Thereby, the vehicle 1 can limit the amount of electric power that is unnecessarily supplied from the high-capacity type battery 30 to the traveling motor 10, i.e., limit a decrease in the voltage of the high-capacity type battery 30, in association with an increase in the number of rotations of the drive wheel 12 and continue stable traveling without changing the torque of the traveling motor 10.

As described above, the control device 100 temporarily absorbs the amount of electric power that changes due to slip that has occurred in the discharging process or the charging process of the high-capacity type battery 30 or the high-power type battery 50 without limiting the torque of the traveling motor 10 immediately when slip has occurred. The control device 100 limits the torque when the amount of electric power that changes due to the slip that has occurred cannot be absorbed.

### [Configuration of Control Device]

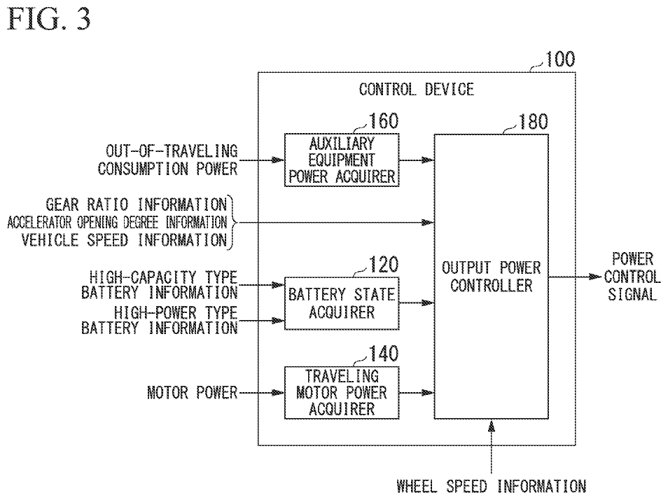

FIG. 3 is a diagram showing an example of a configuration of the control device 100 provided in the vehicle 1 according to the embodiment. The control device 100 includes, for example, a battery state acquirer 120, a traveling motor power acquirer 140, an auxiliary equipment power acquirer 160, and an output power controller 180. In FIG. 3, components of the control device 100 related to the control of the driving force (torque) of the traveling motor 10 are shown.

The battery state acquirer 120 acquires high-capacity type battery information output by the battery sensor 32 and high-power type battery information output by the battery sensor 52. The battery state acquirer 120 outputs the acquired high-capacity type battery information and the acquired high-power type battery information to the output power controller 180. The battery state acquirer 120 is an example of a “first acquirer” in the claims.

The traveling motor power acquirer 140 acquires electric power (hereinafter referred to as “motor power”) that is consumed by the traveling motor 10. The traveling motor power acquirer 140 acquires, for example, a power value after a conversion process of the PDU 20 for driving the traveling motor 10 as the motor power. For example, the traveling motor power acquirer 140 may designate electric power calculated on the basis of a measured value of a power meter (not shown), a voltmeter (not shown), an ammeter (not shown), or the like attached to power wiring between the traveling motor 10 and the PDU 20 as the motor power. The traveling motor power acquirer 140 outputs information of the motor power that has been acquired (hereinafter referred to as “motor power information”) to the output power controller 180. The traveling motor power acquirer 140 is an example of a “second acquirer” in the claims.

The auxiliary equipment power acquirer 160 acquires electric power that is consumed by the auxiliary equipment 90. For example, the auxiliary equipment power acquirer 160 designates electric power calculated on the basis of a measured value of a power meter (not shown), a voltmeter (not shown), an ammeter (not shown), or the like attached to power wiring through which electric power is supplied to the auxiliary equipment 90 as electric power that is consumed by the auxiliary equipment 90. For example, the auxiliary equipment power acquirer 160 may designate electric power calculated on the basis of information such as whether the auxiliary equipment 90 is in an on or off state, information indicating a current use state of the auxiliary equipment 90, and information of a rated value of the auxiliary equipment 90 as electric power that is consumed by the auxiliary equipment 90. The auxiliary equipment power acquirer 160 outputs information of the acquired electric power that is consumed by the auxiliary equipment 90 to the output power controller 180. As described above, the auxiliary equipment 90 is not equipment directly related to the traveling of the vehicle 1. Thus, in the following description, electric power that is consumed by the auxiliary equipment 90 will be referred to as “out-of-traveling consumption power” and information of the out-of-traveling consumption power will be referred to as “out-of-traveling consumption power information.” The auxiliary equipment power acquirer 160 is an example of a “third acquirer” in the claims.

The output power controller 180 controls electric power that is output (supplied) from the PDU 20 to the traveling motor 10 on the basis of information of the gear ratio of the transmission mechanism, information of the accelerator opening degree, information of the vehicle speed, and the like. At this time, the output power controller 180 calculates a current SOC of each battery on the basis of the high-capacity type battery information and the high-power type battery information output by the battery state acquirer 120 and further calculates the upper power limit value in each battery. More specifically, the output power controller 180 calculates the current SOC (a high-capacity type battery-specific SOC) of the high-capacity type battery 30 on the basis of a voltage value and a current value included in the high-capacity type battery information and calculates the upper power limit value of the high-capacity type battery 30 (hereinafter referred to as a “high-capacity type upper power limit value”) on the basis of the calculated high-capacity type battery-specific SOC and the temperature information included in the high-capacity type battery information. Further, the output power controller 180 calculates the current SOC (a high-power type battery-specific SOC) of the high-power type battery 50 on the basis of a voltage value and a current value included in the high-power type battery information and calculates the upper power limit value of the high-power type battery 50 (hereinafter referred to as a “high-power type upper power limit value”) on the basis of the calculated high-power type battery-specific SOC and the temperature information included in the high-power type battery information. The output power controller 180 may further calculate the high-capacity type upper power limit value and the high-power type upper power limit value using an internal resistance value of the corresponding battery included in the battery information. Each of the high-capacity type battery-specific SOC and the high-power type battery-specific SOC may be calculated by the battery state acquirer 120, included in the high-capacity type battery information and the high-power type battery information, and output to the output power controller 180. Subsequently, the output power controller 180 determines the amount of electric power that is output (supplied) from each of the high-capacity type battery 30 and the high-power type battery 50 to the traveling motor 10 via the PDU 20 on the basis of the calculated high-capacity type upper power limit value and the calculated high-power type upper power limit value. The output power controller 180 generates a power control signal for outputting electric power equivalent to the determined amount of electric power to the traveling motor 10 and outputs the generated power control signal to the PDU 20 and the VCU 40. Thereby, the PDU 20 and the VCU 40 output electric power according to the electric power control signal from the high-capacity type battery 30 and the high-power type battery 50. The PDU 20 outputs the electric power output from the high-capacity type battery 30 or electric power obtained by adding the electric power output from the high-power type battery 50 via the VCU 40 to the electric power output from the high-capacity type battery 30 to the traveling motor 10. Thereby, the traveling motor 10 is driven by a driving force (torque) according to the electric power output from the PDU 20. As described above, in the normal traveling of the vehicle 1, the vehicle 1 travels with the rotational power of the traveling motor 10 driven with the electric power determined by the output power controller 180. The high-capacity type upper power limit value is an example of a “first upper power limit value” in the claims and the high-power type upper power limit value is an example of a “second upper power limit value” in the claims.

The output power controller 180 determines whether or not slip has occurred in the vehicle 1 according to whether or not the wheel speed (the rotational speed) of the drive wheel 12 when the vehicle 1 is traveling satisfies a condition of reference (a reference condition). The reference condition is related to an increasing rate of the wheel speed (the number of rotations) of the drive wheel 12. The output power controller 180 sets a reference value of the increasing rate on the basis of the number of rotations of the drive wheel 12 that is assumed to increase by driving the traveling motor 10 according to the determined electric power. The reference value is a value of the increasing rate at which it is determined that slip has occurred in the vehicle 1. The output power controller 180 determines whether or not slip has occurred in the vehicle 1 according to whether or not a current increasing rate of the number of rotations of the drive wheel 12 exceeds the set reference value (whether or not the reference condition is satisfied). When the current increasing rate of the wheel speed (the number of rotations) of the drive wheel 12 represented by the wheel speed information output by the wheel speed sensor 82 corresponds to the reference value (does not satisfy the reference condition), the output power controller 180 determines that no slip has occurred in the vehicle 1. The fact that the increasing rate corresponds to the reference value may include that the current increasing rate of the number of rotations of the drive wheel 12 is within a prescribed range centered on the reference value. On the other hand, when the current increasing rate of the number of rotations of the drive wheel 12 exceeds the reference value (satisfies the reference condition), the output power controller 180 determines that slip has occurred in the vehicle 1. The output power controller 180 may determine whether or not slip has occurred in the vehicle 1 according to whether or not the current increasing rate of the wheel speed (the number of rotations) of the drive wheel 12 represented by the wheel speed information included in the traveling state information output by the vehicle sensor 80 satisfies the reference condition.

When it is determined that slip has occurred in the vehicle 1, the output power controller 180 calculates the amount of electric power that has increased (hereinafter referred to as “overpower”) due to the slip that has occurred on the basis of the motor power information output by the traveling motor power acquirer 140 and the out-of-traveling consumption power information output by the auxiliary equipment power acquirer 160. More specifically, the output power controller 180 calculates the overpower by subtracting the amount of electric power determined to be output (supplied) to the traveling motor 10 and the amount of out-of-traveling consumption power indicated in the out-of-traveling consumption power information from the motor power indicated in the motor power information. The overpower is the amount of electric power to be compensated for in a discharging process on surplus power of the high-capacity type battery 30 or the high-power type battery 50. The surplus power is the amount of electric power obtained by subtracting the amount of electric power being currently output by the battery from the upper power limit value of each battery. The output power controller 180 determines whether to compensate for the calculated overpower in the discharging process on the surplus power of the high-capacity type battery 30 or the high-power type battery 50 or to limit the compensation for the overpower on the basis of the calculated high-capacity type upper power limit value, the calculated high-power type upper power limit value, and the motor power. Limiting the compensation for overpower is, for example, limiting the torque of the traveling motor 10. In the following description, limiting the compensation for the overpower is referred to as “limiting the torque.” At this time, the output power controller 180 may subtract an amount of electric power for limiting the torque from the amount of electric power to be output (supplied) to the traveling motor 10 from a state in which a discharging process has been performed until the surplus power of one or both of the high-capacity type battery 30 and the high-power type battery 50 reaches the upper power limit value or may subtract an amount of electric power for limiting the torque from the amount of electric power to be output to the traveling motor 10 without performing a discharging process (without performing a compensation process) on the surplus power of the high-capacity type battery 30 and the high-power type battery 50. The output power controller 180 determines to compensate for the overpower when the motor power is less than or equal to a maximum value (a maximum power value) of the amount of electric power in the vehicle 1 obtained by combining the high-capacity type upper power limit value and the high-power type upper power limit value and determines to limit the torque with respect to the traveling motor 10 when the motor power exceeds the maximum power value. The output power controller 180 may determine to compensate for the overpower when the motor power is less than or equal to the amount of electric power (a suppliable power value) obtained by subtracting the out-of-traveling consumption power from the maximum power value and determine to limit the torque with respect to the traveling motor 10 when the motor power exceeds the suppliable power value.

When it is determined to compensate for the overpower with the surplus power, the output power controller 180 determines a battery that is allowed to perform an output (discharging) process on the surplus power. Thus, the output power controller 180 calculates the surplus power of each battery on the basis of the upper power limit value of each battery and the amount of electric power being currently output. The output power controller 180 determines a battery that is allowed to output the surplus power with which the overpower is compensated for on the basis of the calculated surplus power of each battery and the overpower. For example, when the surplus power of the high-power type battery 50 (hereinafter referred to as “high-power type surplus power”) is greater than or equal to the overpower, the output power controller 180 determines the high-power type battery 50 as a battery for outputting the surplus power and compensating for the overpower with the output surplus power. For example, when the surplus power of the high-capacity type battery 30 (hereinafter referred to as “high-capacity type surplus power”) is greater than or equal to the overpower, the output power controller 180 may determine the high-capacity type battery 30 as a battery for outputting the surplus power and compensating for the overpower with the output surplus power. For example, when the high-power type surplus power is less than or equal to the overpower and the high-capacity type surplus power is less than or equal to the overpower but total surplus power obtained by combining the high-power type surplus power and the high-capacity type surplus power is greater than or equal to the overpower, the output power controller 180 may determine each of the high-power type battery 50 and the high-capacity type battery 30 as a battery that is allowed to output the surplus power and compensate for the overpower with the surplus power. After the battery that is allowed to output the surplus power is determined, the output power controller 180 generates a power control signal for outputting the surplus power corresponding to the overpower from the determined battery to the traveling motor 10 and outputs the power control signal to the PDU 20 and the VCU 40. Thereby, the PDU 20 and the VCU 40 cause surplus power according to the power control signal to be output from the high-capacity type battery 30 and/or the high-power type battery 50. Thereby, the traveling motor 10 is driven by a driving force (torque) output from the PDU 20 according to electric power with which the overpower is compensated for. Thereby, the vehicle 1 can limit the unnecessary supply of electric power from the high-capacity type battery 30 to the traveling motor 10 due to an increase in the number of rotations of the drive wheel 12 in association with slip that has occurred (limit the decrease in the voltage in the high-capacity type battery 30) and continue stable traveling without changing the torque of the traveling motor 10.

On the other hand, when it is determined to limit the torque with respect to the traveling motor 10, the output power controller 180 calculates the amount of electric power to be reduced (hereinafter referred to as a “power reduction amount”) so that the electric power to be supplied to the traveling motor 10 is reduced. More specifically, the output power controller 180 calculates the power reduction amount by subtracting the total surplus power from the overpower. The output power controller 180 generates a power control signal for subtracting the calculated power reduction amount from the electric power to be output to the traveling motor 10 and outputs the power control signal to the PDU 20 and the VCU 40. Thereby, the PDU 20 and the VCU 40 cause electric power reduced in accordance with the power control signal to be output from the high-capacity type battery 30 and/or the high-power type battery 50. Thereby, the traveling motor 10 is driven by a driving force (torque) according to low power output from the PDU 20 and the torque is limited. In the vehicle 1, the slip that has occurred converges due to the torque limitation with respect to the traveling motor 10. The torque limited in the traveling motor 10 is expressed by, for example, the following Eq. (1).

Tr=Pr÷(N×2π/60/1000) (1)

In the above Eq. (1), Tr denotes torque [Nm] that is limited, Pr denotes a power reduction amount [kW], and N denotes the number of rotations [rpm] of the drive wheel 12 detected by the wheel speed sensor 82.

### [Example of Control of Power Supply to Traveling Motor]

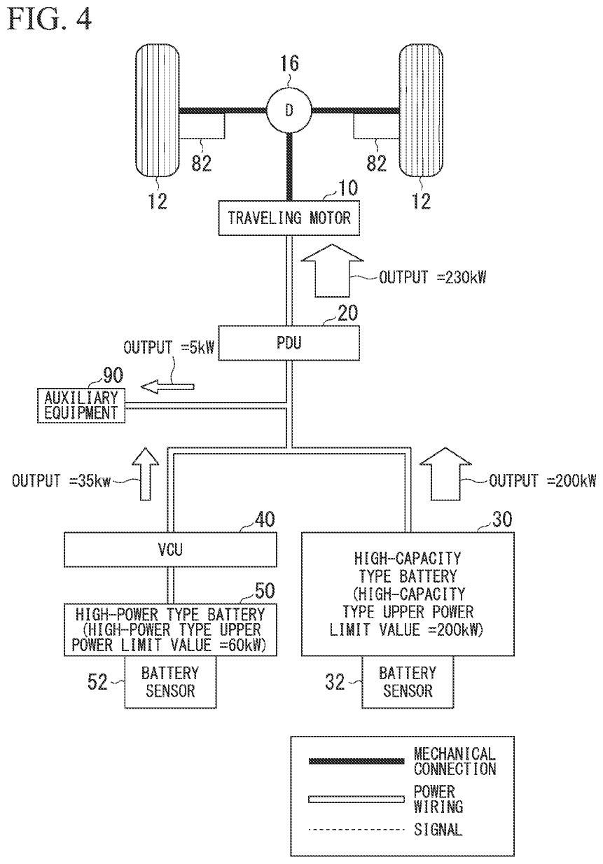

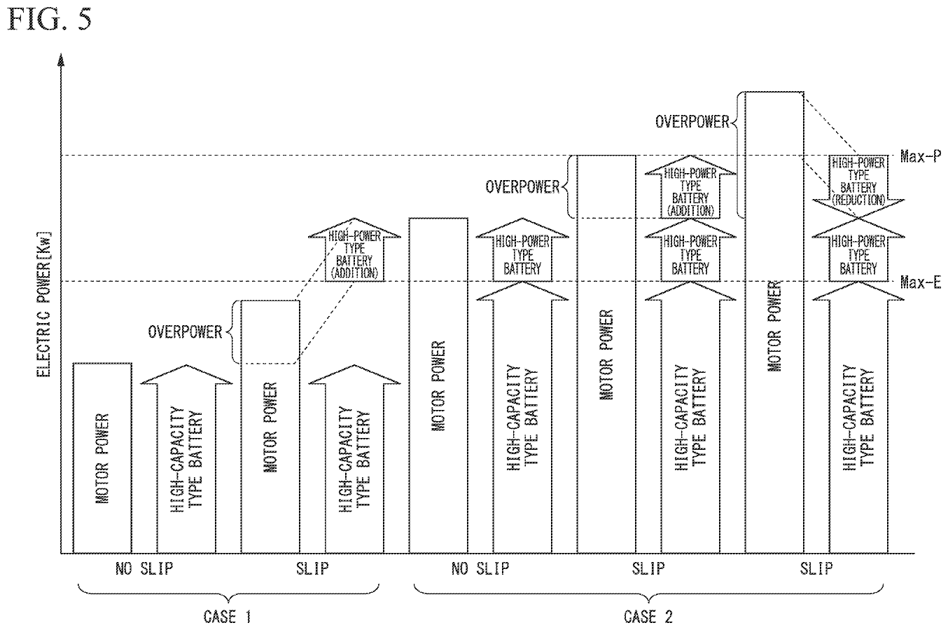

Here, an example of control of electric power that is output to the traveling motor 10 will be described. FIG. 4 is a diagram showing an example of a state in which electric power is output to the traveling motor 10 under control of the control device 100 provided in the vehicle 1 according to the embodiment. FIG. 5 is a diagram schematically showing an example of a state in which the control device 100 provided in the vehicle 1 according to the embodiment controls the electric power to be output to the traveling motor 10.

In FIG. 4, an example in which the high-capacity type upper power limit value of the high-capacity type battery 30 mounted in the vehicle 1 is 200 [kW] and the high-power type upper power limit value of the high-power type battery 50 is 60 [kW] is shown. FIG. 4 is an example of a state in which no slip has occurred in the vehicle 1. In the control device 100, as described above, the output power controller 180 controls electric power to be output (supplied) from the PDU 20 to the traveling motor 10 on the basis of the information of the gear ratio of the transmission mechanism, the information of the accelerator opening degree, the information of the vehicle speed, and the like). Further, the output power controller 180 causes electric power to be output (supplied) to the auxiliary equipment 90 when the driver activates the auxiliary equipment 90. In FIG. 4, a state in which an electric power of 200 [kW] is supplied from the high-capacity type battery 30 and an electric power of 35 [kW] is supplied from the high-power type battery 50, i.e., a total electric power of 235 [kW] is supplied from the high-capacity type battery 30 and the high-power type battery 50, is shown. In FIG. 4, within the electric power of 235 [kW], 230 [kW] is output to the traveling motor 10 and 5 [kW] is output to the auxiliary equipment 90. In this case, the high-capacity type surplus power of the high-capacity type battery 30 is 0 [kW] and the high-power type surplus power of the high-power type battery 50 is 25 [kW]. When slip has occurred in the vehicle 1 in this state, the control device 100 (more specifically, the output power controller 180) can cause the high-power type surplus power of the high-power type battery 50 to be output within 25 [kW] in the discharging process and compensate for the overpower with the high-power type surplus power.

In FIG. 5, some examples when the control device 100 causes electric power to be output (supplied) to the traveling motor 10 are shown. In FIG. 5, for the sake of simplicity of description, the electric power to be output (supplied) to the auxiliary equipment 90 is omitted. In FIG. 5, the motor power and the electric power output from each battery in each of the cases where no slip has occurred in the vehicle 1 and slip has occurred in the vehicle 1 are shown side by side. Case 1 shown in FIG. 5 is an example in which the electric power output to the traveling motor 10 by the control device 100 is only the electric power stored in the high-capacity type battery 30 and case 2 is an example in which the electric power output to the traveling motor 10 by the control device 100 is electric power stored in each of the high-capacity type battery 30 and the high-power type battery 50 as in the example shown in FIG. 4.

In case 1, when no slip has occurred, the motor power and the electric power output from the high-capacity type battery 30 by the control device 100 (more specifically, the output power controller 180) have similar amounts of electric power. If slip occurs in the vehicle 1 in this state, the amount of electric power that is the motor power may be increased by the amount of the overpower. At this time, when the control device 100 determines to compensate for the overpower with the surplus power, the increased overpower is compensated for with the surplus power of one or both batteries. In case 1 shown in FIG. 5, a state in which the high-power type battery 50 is allowed to output (add) the high-power type surplus power and compensate for the overpower with the output (added) high-power type surplus power is shown. As described above, the control device 100 may cause the high-capacity type battery 30 to output the high-capacity type surplus power and compensate for the overpower with the output high-capacity type surplus power. In case 1, even if the high-capacity type battery 30 is allowed to output the high-capacity type surplus power and compensate for the overpower with the output high-capacity type surplus power, a compensation result does not exceed a high-capacity type upper power limit value Max-E of the high-capacity type battery 30. Thus, the control device 100 may not perform control for allowing the high-capacity type battery 30 to output the high-capacity type surplus power. That is, in case 1, the control device 100 may allow an increase in the motor power without controlling anything with respect to the overpower due to the slip that has occurred.

In case 2, when no slip has occurred, the motor power and the electric power output from the high-capacity type battery 30 and the high-power type battery 50 by the control device 100 have similar amounts of electric power. If slip occurs in the vehicle 1 in this state, the amount of electric power that is the motor power may be increased by the amount of the overpower. At this time, when the control device 100 determines to compensate for the overpower with the surplus power, the increased overpower is compensated for with the high-power type surplus power of the high-power type battery 50. In case 2 shown in FIG. 5, a state in which the high-power type battery 50 is allowed to output (add) the high-power type surplus power and compensate for the overpower with the output (added) high-power type surplus power is shown. In this case, the high-power type surplus power to be output to the high-power type battery 50 is the amount of electric power less than or equal to a high-power type upper power limit value Max-P in the high-power type battery 50. Here, when the overpower due to the slip that has occurred in the vehicle 1 exceeds the high-power type upper power limit value Max-P, i.e., when the overpower due to the slip that has occurred in the vehicle 1 exceeds the maximum power value in the vehicle 1 obtained by combining the high-capacity type upper power limit value Max-E and the high-power type upper power limit value Max-P, the control device 100 limits the torque. In case 2 shown in FIG. 5, a state in which the power reduction amount corresponding to the overpower equivalent to the amount exceeding the maximum power value is subtracted from the high-power type surplus power output by the high-power type battery 50 is shown.

### [Process of Control Device]

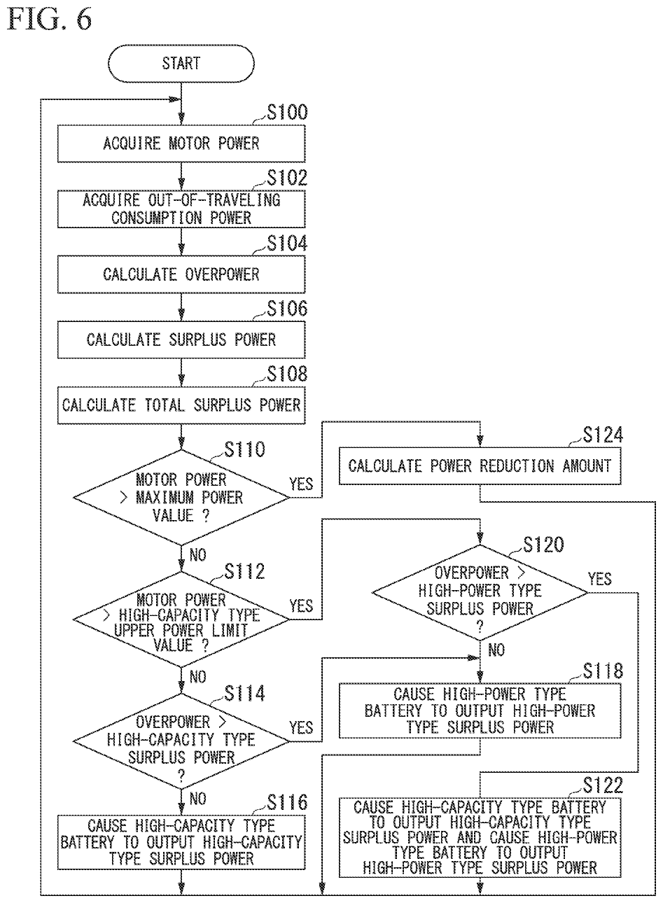

FIG. 6 is a flowchart showing an example of a flow of a process executed when the electric power to be output to the traveling motor 10 is controlled in the control device 100 provided in the vehicle 1 according to the embodiment. In FIG. 6, a process to be performed when the control device 100 determines that slip has occurred in the vehicle 1 after determining the amount of electric power for normal traveling in the vehicle 1 and outputting a power control signal is shown. The process of the present flowchart is iteratively executed while the vehicle 1 is traveling.

The traveling motor power acquirer 140 acquires motor power (step S100). The traveling motor power acquirer 140 outputs motor power information representing the acquired motor power to the output power controller 180.

The auxiliary equipment power acquirer 160 acquires out-of-traveling consumption power (step S102). The auxiliary equipment power acquirer 160 outputs out-of-traveling consumption power information indicating the acquired out-of-traveling consumption power to the output power controller 180.

The output power controller 180 calculates overpower on the basis of the motor power output by the traveling motor power acquirer 140 and the out-of-traveling consumption power output by the auxiliary equipment power acquirer 160 (step S104).

The output power controller 180 calculates surplus power of the batteries (high-capacity type surplus power and high-power type surplus power) on the basis of the high-capacity type upper power limit value of the high-capacity type battery 30 and the high-power type upper power limit value of the high-power type battery 50 calculated when the amount of electric power for normal traveling in the vehicle 1 is determined and the amount of electric power being currently output from each battery (step S106). The output power controller 180 calculates total surplus power obtained by combining the calculated high-capacity type surplus power and the calculated high-power type surplus power (step S108).

The output power controller 180 determines whether or not the motor power exceeds a maximum power value obtained by combining the high-capacity type upper power limit value and the high-power type upper power limit value (step S110). When it is determined that the motor power does not exceed the maximum power value (or is less than or equal to the maximum power value) in step S110, the output power controller 180 determines to compensate for the overpower with the surplus power of the high-capacity type battery 30 or the high-power type battery 50 and determines whether or not the motor power exceeds the high-capacity type upper power limit value (step S112). When it is determined that the motor power does not exceed the high-capacity type upper power limit value (or is less than or equal to the high-capacity type upper power limit value) in step S112, the output power controller 180 determines whether or not the overpower exceeds the high-capacity type surplus power (step S114).

When it is determined that the overpower does not exceed the high-capacity type surplus power (or is less than or equal to the high-capacity type upper power limit value) in step S114, the output power controller 180 causes the high-capacity type battery 30 to output the high-capacity type surplus power (step S116). That is, the output power controller 180 generates a power control signal for causing the high-capacity type battery 30 to output the high-capacity type surplus power equivalent to the overpower and outputs the power control signal to the PDU 20. The output power controller 180 returns the process. In this case, the output power controller 180 may not perform any control as described above.

On the other hand, when it is determined that the overpower exceeds the high-capacity type surplus power in step S114, the output power controller 180 causes the high-power type battery 50 to output the high-power type surplus power (step S118). That is, the output power controller 180 generates a power control signal for causing the high-power type battery 50 to output the high-power type surplus power equivalent to the overpower and outputs the power control signal to the VCU 40. The output power controller 180 returns the process.

On the other hand, when it is determined that the motor power exceeds the high-capacity type upper power limit value in step S112, the output power controller 180 determines whether or not the overpower exceeds the high-power type surplus power (step S120). When it is determined that the overpower does not exceed the high-power type surplus power (or is less than or equal to the high-power type upper power limit value) in step S120, the output power controller 180 moves the process to step S118 and causes the high-power type battery 50 to output the high-power type surplus power.

On the other hand, when it is determined that the overpower exceeds the high-power type surplus power in step S120, the output power controller 180 causes the high-capacity type battery 30 to output the high-capacity type surplus power and causes the high-power type battery 50 to output the high-power type surplus power (step S122). That is, the output power controller 180 generates a power control signal for causing the high-capacity type battery 30 to output the high-capacity type surplus power for a part of the overpower and causing the high-power type battery 50 to output the high-power type surplus power for the remaining part of the overpower and outputs the generated power control signal to the PDU 20 and VCU 40. The output power controller 180 returns the process.

On the other hand, when it is determined that the motor power does exceed the maximum power value in step S110, the output power controller 180 determines to limit the torque with respect to the traveling motor 10 and calculates a power reduction amount (step S124). The output power controller 180 generates a power control signal for subtracting electric power equivalent to the calculated power reduction amount from electric power to be output to the traveling motor 10 and outputs the power control signal to the PDU 20 and the VCU 40. The output power controller 180 returns the process.

According to the flow of the above-described process, when slip has occurred in the vehicle 1, the control device 100 does not immediately limit the torque and causes the traveling motor 10 to be driven continuously by causing the amount of electric power (overpower) of the traveling motor 10 increased due to the slip that has occurred to be compensated for with surplus power of one or both of the high-capacity type battery 30 and the high-power type battery 50. In the vehicle 1 equipped with the control device 100, even if slip occurs, the torque of the traveling motor 10 does not change immediately and more stable traveling can be continued.

As described above, according to the vehicle 1 of the embodiment, when slip has occurred, the control device 100 temporarily absorbs a change in the amount of electric power by compensating for the amount of electric power of the traveling motor 10 changed due to the slip that has occurred with surplus power of the high-capacity type battery 30 or the high-power type battery 50. At this time, the control device 100 can reduce the number of factors that accelerate the deterioration of each battery such as a decrease in a voltage because a changed amount of electric power is absorbed with surplus power less than or equal to the upper power limit value in the high-capacity type battery 30 or the high-power type battery 50. Further, in the vehicle 1 of the embodiment, the control device 100 absorbs the changed amount of electric power, thereby limiting a sudden change in the torque of the traveling motor 10 and stabilizing the behavior of the vehicle 1. In the vehicle 1 of the embodiment, the control device 100 limits the torque of the traveling motor 10 when a state in which it is difficult to absorb the amount of electric power changed by the slip that has occurred is reached. As described above, in the vehicle 1 of the embodiment, when slip has occurred, the control device 100 controls the charging and discharging processes of the high-capacity type battery 30 and the high-power type battery 50 from the viewpoints of both protection of the battery and stabilization of the behavior of the vehicle 1.

According to the above-described embodiment, the vehicle 1 includes the battery state acquirer 120 configured to acquire a state of the high-capacity type battery 30 and a state of the high-power type battery 50; the traveling motor power acquirer 140 configured to acquire information of motor power that is consumed by the traveling motor 10 that outputs motive power for traveling; the wheel speed sensor 82 (or the vehicle sensor 80) configured to detect a rotation state of the drive wheel 12 driven by the traveling motor 10; and the control device 100 configured to calculate a high-capacity type upper power limit value that is an upper power limit value of the high-capacity type battery 30 on the basis of the state of the high-capacity type battery 30, calculate a high-power type upper power limit value that is an upper power limit value of the high-power type battery 50 on the basis of the state of the high-power type battery 50, and control the amount of electric power that is supplied from each of the high-capacity type battery 30 and the high-power type battery 50 to the traveling motor 10 on the basis of the calculated high-capacity type upper power limit value and the calculated high-power type upper power limit value, wherein the control device 100 determines whether to compensate for the motor power (overpower) equivalent to the amount of change due to a change in the rotation state with electric power of the high-capacity type battery 30 and the high-power type battery 50 or limit compensation for the motor power (the overpower) equivalent to the amount of change on the basis of the high-capacity type upper power limit value, the high-power type upper power limit value, and the motor power when the change in the rotation state satisfies a reference condition. Therefore, when charging/discharging power of the battery due to slip that has occurred in the vehicle 1 is controlled, it is possible to reduce the number of factors that cause the battery to deteriorate and to stabilize the behavior of the vehicle 1. Thereby, in the vehicle 1 of the embodiment, it is possible to enhance the commercial value and the safety of traveling.

The embodiment described above can be represented as follows.

A vehicle control device including:

a hardware processor, and

a storage device storing a program,

wherein the hardware processor reads and executes the program stored in the storage device to:

acquire a state of a first battery and a state of a second battery;

acquire information of motor power that is consumed by a motor that outputs motive power for traveling;

detect a rotation state of a drive wheel driven by the motor;

calculate a first upper power limit value that is an upper power limit value of the first battery on the basis of the state of the first battery;

calculate a second upper power limit value that is an upper power limit value of the second battery on the basis of the state of the second battery;

control the amount of electric power that is supplied from each of the first battery and the second battery to the motor on the basis of the calculated first and second upper power limit values; and

determine whether to compensate for the motor power equivalent to the amount of change due to a change in the rotation state with electric power of the first battery and the second battery or limit compensation for the motor power equivalent to the amount of change on the basis of the first upper power limit value, the second upper power limit value, and the motor power when the change in the rotation state satisfies a reference condition.

Although modes for carrying out the present invention have been described using embodiments, the present invention is not limited to the embodiments and various modifications and substitutions can also be made without departing from the scope and spirit of the present invention.

What is claimed is:

1. A vehicle control device comprising a processor configured to execute computer-readable instructions to perform:
acquiring a state of a first battery and a state of a second battery;
acquiring information of motor power that is consumed by a motor that outputs motive power for traveling;
detecting a rotation state of a drive wheel driven by the motor;
calculating a first upper power limit value that is an upper power limit value of the first battery on the basis of the state of the first battery;
calculating a second upper power limit value that is an upper power limit value of the second battery on the basis of the state of the second battery; and
controlling an amount of electric power that is supplied from each of the first battery and the second battery to the motor on the basis of the calculated first and second upper power limit values,
wherein the controlling the amount of electric power comprises determining whether to compensate for the motor power equivalent to an amount of change due to a change in the rotation state with electric power of the first battery and the second battery or limit compensation for the motor power equivalent to the amount of change on the basis of the first upper power limit value, the second upper power limit value, and the motor power when the change in the rotation state satisfies a reference condition.

2. The vehicle control device according to claim 1,
wherein the reference condition is related to an increasing rate of the number of rotations of the drive wheel representing the rotation state, and
wherein the processor is configured to execute the computer-readable instructions to perform: determining that the change in the rotation state satisfies the reference condition when the increasing rate exceeds a reference value.

3. The vehicle control device according to claim 2,
wherein the processor is configured to execute the computer-readable instructions to perform:
determining to compensate for the motor power equivalent to the amount of change when the motor power is less than or equal to a maximum power value obtained by combining the first upper power limit value and the second upper power limit value; and
determining to limits the compensation for the motor power equivalent to the amount of change when the motor power exceeds the maximum power value.

4. The vehicle control device according to claim 2,
wherein the processor is configured to execute the computer-readable instructions to perform:
acquiring out-of-traveling consumption power as electric power to be consumed outside of the motor;
determining to compensate for the motor power equivalent to the amount of change when the motor power is less than or equal to a value obtained by subtracting the out-of-traveling consumption power from a maximum power value obtained by combining the first upper power limit value and the second upper power limit value; and
determining to limit the compensation for the motor power equivalent to the amount of change when the motor power exceeds the value obtained by subtracting the out-of-traveling consumption power from the maximum power value.

5. The vehicle control device according to claim 3, wherein, when it is determined to compensate for the motor power equivalent to the amount of change and when the motor power is less than or equal to the maximum power value and the motor power is less than or equal to the first upper power limit value, the processor is configured to execute the computer-readable instructions to perform: causing the motor power equivalent to the amount of change to be compensated for with surplus power less than or equal to the first upper power limit value in the first battery and maintains an amount of electric power to be supplied from the second battery.

6. The vehicle control device according to claim 3, wherein, when it is determined to compensate for the motor power equivalent to the amount of change, the processor is configured to execute the computer-readable instructions to perform: causing the motor power equivalent to the amount of change to be compensated for with surplus power less than or equal to the second upper power limit value in the second battery.

7. The vehicle control device according to claim 1,
wherein the first battery is a high-capacity and low-power battery, and
wherein the second battery is a battery having lower capacity and higher power than the first battery.

8. A vehicle control method comprising:
acquiring, by a computer, a state of a first battery and a state of a second battery;
acquiring, by the computer, information of motor power that is consumed by a motor that outputs motive power for traveling;
detecting, by the computer, a rotation state of a drive wheel driven by the motor;
calculating, by the computer, a first upper power limit value that is an upper power limit value of the first battery on the basis of the state of the first battery;
calculating, by the computer, a second upper power limit value that is an upper power limit value of the second battery on the basis of the state of the second battery;
controlling, by the computer, an amount of electric power that is supplied from each of the first battery and the second battery to the motor on the basis of the calculated first and second upper power limit values; and
determining, by the computer, whether to compensate for the motor power equivalent to an amount of change due to a change in the rotation state with electric power of the first battery and the second battery or limit compensation for the motor power equivalent to the amount of change on the basis of the first upper power limit value, the second upper power limit value, and the motor power when the change in the rotation state satisfies a reference condition.

9. A non-transitory computer-readable storage medium storing a program for causing a computer to:
acquire a state of a first battery and a state of a second battery;
acquire information of motor power that is consumed by a motor that outputs motive power for traveling;
detect a rotation state of a drive wheel driven by the motor;
calculate a first upper power limit value that is an upper power limit value of the first battery on the basis of the state of the first battery;
calculate a second upper power limit value that is an upper power limit value of the second battery on the basis of the state of the second battery;
control an amount of electric power that is supplied from each of the first battery and the second battery to the motor on the basis of the calculated first and second upper power limit values; and
determine whether to compensate for the motor power equivalent to an amount of change due to a change in the rotation state with electric power of the first battery and the second battery or limit compensation for the motor power equivalent to the amount of change on the basis of the first upper power limit value, the second upper power limit value, and the motor power when the change in the rotation state satisfies a reference condition.
